(19) United States
(12) Patent Application Publication
(10) Pub. No.: US 2014/0214539 A1
(43) Pub. Date: Jul. 31, 2014

(54) METHOD AND SYSTEM FOR PROVIDING AN ADVERTISEMENT SERVICE USING GAME

(71) Applicant: Jong Sung Kim, Goyang-si (KR)

(72) Inventor: Jong Sung Kim, Goyang-si (KR)

(73) Assignee: Kamsung Co., Ltd., Goyang-si (KR)

(21) Appl. No.: 14/239,070

(22) PCT Filed: Aug. 16, 2012
(86) PCT No.: PCT/KR2012/006510

§ 371 Date: Feb. 14, 2014

(30) Foreign Application Priority Data
Aug. 17, 2011 (KR) 10-2011-0081632

(51) Int. Cl. G06Q 30/02

(52) U.S. Cl. CPC G06Q 30/0255
USPC 705/14.53

(57) ABSTRACT

A method for providing an advertisement service using a game includes extracting advertisement groups to be exposed and determining any one of the extracted advertisement groups to be exposed as a target advertisement group to be serviced; and combining a game ability of the game participant client with at least any one of a game mileage of the determined target advertisement group, group level of the determined target advertisement group, times of game experience of the game participant client, and time elapsed since the game participant client has played the last game. Further, the method includes selecting an advertisement game having a game level corresponding to the result value of the combination; providing the selected advertisement game to the game participant client; and storing accumulatively information related to the game play result as a personal history record of the game participant client.

### CROSS-REFERENCE TO RELATED APPLICATIONS

This application is the U.S. National Stage of International Patent Application No. PCT/KR2012/006510 filed on Aug. 16, 2012, which claims priority to Korean Patent Application No. 10-2011-0081632 filed on Aug. 17, 2011, the disclosures of which are hereby incorporated by reference in their entireties.

### TECHNICAL FIELD

The present invention is related to an advertisement service technique; and more specifically, to a method and system for providing an advertisement service using a game suitable for providing an online advertisement service to clients (game participant clients) using a game with various level of playing a game.

### BACKGROUND ART

As is well known, conventional advertisements are realized through a variety of advertisement media such as broadcasting media, newspaper media, internet media, printed materials, etc. In recent years, by virtue of a rapid spread of internet service, etc., internet advertisement (online advertisement) at shopping malls, portal sites, or the like is on a rapidly increasing trend.

In such online advertisements, banner advertisements using an advertisement window of web pages or WAP pages or advertisements using advertising pages become mainstream, and also an advertising method of creating advertising massages (advertising SMS, advertising MMS, etc.) and distributing to unspecified number of wireless clients (mobile terminals) is mainly utilized.

Thus, clients may come into contacts with a variety of advertisements (advertising materials) through banner advertisements of web pages or advertising pages of the sites accessed by themselves, or may come into contacts with a variety of advertisements (advertising materials) through advertising massages receiving automatically through mobile terminals.

### DISCLOSURE

### Technical Problem

However, the conventional advertising method of distributing advertising materials through banner advertisements of web page or WAP page or advertising pages, or sending advertising massages to unspecified number of mobile terminals is a random advertising method that users of mobile terminals do not want. Thus, most of the users actually do not have special interests, and rather just cut off interests at a glance, thereby leaving a problem that advertisers inevitably have limitations to achieve a great effectiveness of advertisement as much as advertisers want.

### Technical Solution

In accordance with an aspect of the present invention, there is provided a method for providing an advertisement service using a game, the method including: when receiving a request for the game from a game participant client, a first step of extracting advertisement groups to be exposed on the basis of information related to an advertisement target specified by an advertiser client and personal information of the game participant client and determining any one of the extracted advertisement groups to be exposed as a target advertisement group to be serviced; a second step of combining a game ability of the game participant client with at least any one of a game mileage of the determined target advertisement group, group level of the determined target advertisement group, times of game experience of the game participant client in the determined target advertisement group, and time elapsed since the game participant client has played the last game in the determined target advertisement group; a third step of selecting an advertisement game having a game level corresponding to the result value of the combination from the determined target advertisement group, wherein the determined target advertisement group includes a plurality of advertisement games, the advertisement games having different game levels each other and being generated from the same advertisement; a fourth step of providing the selected advertisement game to the game participant client so as for the game participant client to play the selected advertisement game; and when the selected advertisement game is terminated, a fifth step of storing accumulatively information related to the game play result derived from playing the selected advertisement game in a database as a personal history record of the game participant client.

In accordance with another aspect of the present invention, there is provided a method for providing an advertisement service using a game, the method including: when an advertisement to be serviced is received from each advertiser client, a first step of editing the received advertisement to generate a plurality of advertisement games having different game levels each other; a second step of registering the plurality of advertisement games, which have different game levels each other and are generated from the same advertisement, as one advertisement group; when receiving a request for a game from a game participant client, a third step of extracting advertisement groups to be exposed on the basis of information related to an advertisement target specified by an advertiser client and personal information of the game participant client and determining any one of the extracted advertisement groups as a target advertisement group to be serviced; a third step of combining at least any one of a game mileage of the determined target advertisement group, group level of the determined target advertisement group, times of game experience of the game participant client in the determined target advertisement group, and time elapsed since the game participant client has played the last game in the determined target advertisement group, with a game ability of the game participant client; a fifth step of selecting an advertisement game having a game level corresponding to the result value of the combination from the determined target advertisement group; a sixth step of providing the selected advertisement game to the game participant client so as for the game participant client to play the selected advertisement game; and when the selected advertisement game is terminated, a seventh step of storing accumulatively information related to the game play result derived from playing the selected advertisement game in a database as a personal history record of the game participant client.

In accordance with still another aspect of the present invention, there is provided a system for providing an advertisement service using a game, the system including: a game generation block configured to generate a plurality of advertisement games having different game levels each other through editing an advertisement provided by each advertiser client and register the plurality of advertisement games, which have different game levels each other and are generated from the same advertisement received, in the database as an advertisement group, wherein the plurality of advertisement games; an advertisement group determination block, upon receiving a request for a game from a game participant client, configured to extract advertisement groups to be exposed on the basis of information related to an advertisement target specified by an advertiser client and personal information of the game participant client and determines any one of the extracted advertisement groups to be exposed as a target advertisement group to be serviced; a combination block configured to combine at least any one of a game mileage of the determined target advertisement group, group level of the determined target advertisement group, times of game experience of the game participant client in the determined target advertisement group, and time elapsed since the game participant client has played the last game in the determined target advertisement group, with a game ability of the game participant client; a game play block configured to select an advertisement game having a game level corresponding to the result value of the combination from the determined target advertisement group and provide the selected advertisement game to the game participant client so as for the game participant client to play the advertisement game; and a game history record management block, when the selected advertisement game is terminated, configured to store accumulatively information related to the game play result derived from playing the selected advertisement game in a database as a personal history record of the game participant client.

### Advantageous Effects

In accordance with the present invention, an effectiveness of advertisement can be enhanced dramatically in a way of grouping one advertisement into one advertisement group by editing the one advertisement into a plurality of advertisement games having different game levels each other, and when receiving a request of game from a game participant client, on the basis of the result value from the combination of a game ability of the game participant client with at least any one of game mileage for the advertisement group to be determined for a service, group level of the relevant advertisement group, times of game experience of game participant client for the relevant advertisement group and time elapsed since the game participant client has played the last game of the relevant advertisement group, providing the selected advertisement game to the game participant client so as for the game participant client to play the selected advertisement game, thereby doubling advertisement interest and advertisement awareness of user.

Further, in accordance with the present invention, an effectiveness of advertisement with a high royalty can be realized by providing a game mileage corresponding to every time of playing an advertisement game to a game participant client.

### DESCRIPTION OF DRAWINGS

FIG. 1 is a schematic diagram of an advertisement service system suitable for utilizing an advertisement service technique using a game, in accordance with an embodiment of the present invention.

FIG. 2 is a block diagram of a system for an advertisement service using a game, in accordance with an embodiment of the present invention.

FIG. 3 is a flow chart illustrating a main process for registering an advertisement service for clients, in accordance with the present invention.

FIG. 4 is a flow chart illustrating a main process for providing clients with an advertisement service using a game, in accordance with an embodiment of the present invention.

FIG. 5 is flow chart illustrating a main process of performing the re-evaluation of a group level of each advertisement group and the reflection on the adjustment of the group level, in accordance with the present invention.

### BEST MODE

In the following description, well-known functions or constitutions will not be described in detail if they would obscure the invention in unnecessary detail. Further, the terminologies to be described below are defined in consideration of functions in the invention and may vary depending on a user's or operator's intention or practice. Accordingly, the definition may be made on a basis of the content throughout the specification.

Hereinafter, desired embodiments of the present invention will be described in detail with reference to the accompanying drawings.

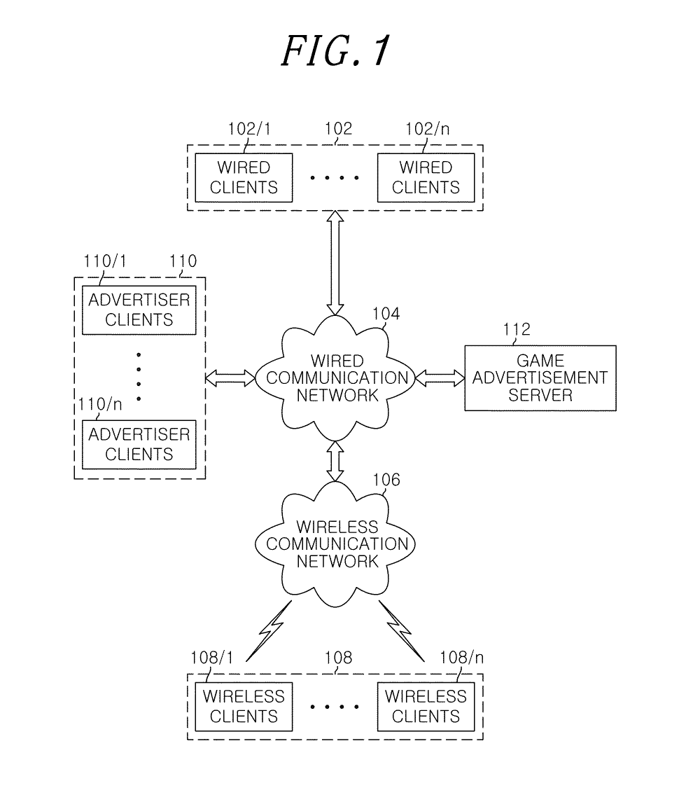

FIG. 1 is a schematic diagram of an advertisement service system suitable for utilizing an advertisement service technique using a game, in accordance with an embodiment of the present invention. The advertisement service system may include a wired client group 102 having a plurality of wired clients 102/1-102/n, a wired communication network 104, a wireless communication network 106, a wireless client group 108 having a plurality of wireless clients 108/1-108/n, an advertiser client group 110 having a plurality of advertiser clients 110/1-110/n, and a game advertisement server 112.

Referring to FIG. 1, each of wired clients 102/1-102/n within the wired client group 102 may be an user terminal (e.g., PC system, notebook, netbook, wired communication terminal, etc.) accessible to the game advertisement server 112 via the wired communication network 104 such as the Internet, etc., using a communication means such as leased-line, ADSL, modem, etc. Such wired clients 102/1-102/n may be served by an advertisement game service and a mileage service provided by playing an advertisement game, and the like provided online by the game advertisement server 12, in accordance with the present invention. In this regard, the wired client may mean for example, a wired game participant client.

Here, the advertisement game may be a puzzle game with puzzles composing of a still image and a moving image, etc., as well as a hidden object game and a wrong picture find game, etc., and the game mileage may be, for example, cash, a point mileage usable for online goods, etc.

To this end, each of wired clients 102/1-102/n may be registered as a member of service user by providing member information and personal information to the game advertisement server 112. The member information may be, for example, name, e-mail address, mobile phone number, etc., and the personal information may be, for example, gender, age, hobby, region, interests, occupational cluster, etc.

Further, each of the wireless clients 108/1-108/n within the wireless client group 108 may be a portable wireless terminal (for example, mobile phone, PDA phone, DMB phone, PMP, HSPDA phone, smart phone, I-pad, tablet PC, Netbook, notebook, etc.) of the user who wants to receive an advertisement game service. Each of the wireless clients 108/1-108/n may be connected to the game advertisement server 112 via a connection path through the wireless communication network 106 and the wired communication network 104, and whereby, in the same manner as the wired client, the wireless client is capable of receiving an advertisement game service, and a game mileage service acquired by playing an advertisement game provided online by the game advertisement server 112, in accordance with the present invention. In this regard, the wireless client may mean, for example, a wireless game participant client.

Here, the wired network 104 may mean a communication network including the wired Internet, etc., and a wireless communication network 106 may mean, for example, any one of a second generation (2G) network, a third generation (3G) network, a fourth generation (4G), and a fifth generation (5G) network, or a wireless communication network including at least two wireless networks multiply.

Next, each of the advertiser clients 110/1-110/n within the advertiser client group 110 may mean a computer or a server on the side of the advertiser who provides an advertisement for advertising to each client (wired or wireless game participant client) to the game advertisement server 112. Although not shown in FIG. 1, each advertiser client, of course, same as each of the wireless clients being provided with advertisement game services, may be a wireless advertiser client accessible to the game advertisement server 112 via the wired communication network 104 and the wireless communication network 106.

Here, when each advertiser client transmits an advertisement to the game advertisement server 112 to request an advertisement, the advertiser client may quote an advertisement pricing or specify or select an exposing object of advertisement. Specifying the exposing object of advertisement may be realized by a selection of personal information (e.g., at least one of gender, age, hobby, region, interests, occupational cluster) of the user (a member of service user). When the advertisement client registers an advertisement in the game advertisement server 112, for example, the advertisement client may specify information related to an advertisement target in a way of selecting male, twenties, capital territory, fishing, etc.

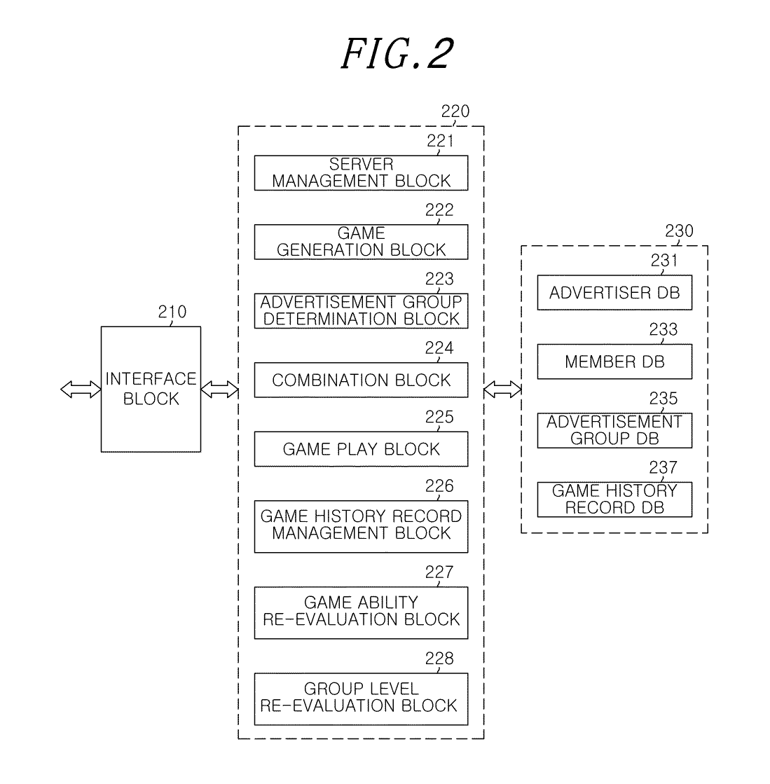

The game advertisement server 112 means a system for an advertisement service of the present invention that provides an advertisement game service as well as a variety of services related to the play of an advertisement game to each client (wired or wireless game participant client). The game advertisement server 112 may be configured as shown exemplarily in FIG. 2. Hereinafter, a variety of services executing in the game advertisement server 112 will be described in detail with reference to FIG. 2.

FIG. 2 is a block diagram of a system for an advertisement service using a game, in accordance with an embodiment of the present invention. The advertisement service system in general, may include an interface block 210, an advertisement game service module 220, and a database module 230. The advertisement game service module 220 may include a server management block 221, a game generation block 222, an advertisement group determination block 223, a combination block 224, a game play block 225, a game history record management block 226, a game ability re-evaluation block 227, and a group level re-evaluation block 228. The database module 230 may include an advertiser DB 231, a member DB 233, and a game history record DB 237.

Referring to FIG. 2, when the server management block 221 receives member information of an advertiser to be provided by an advertiser client via the interface block 210 to join as a member of advertiser, the server management block 221 may register (store) the member information in the advertiser DB 231 within the database module 230. Further, when the server management block 221 receives member information and tendency information to be provided by a client (wired or wireless client) via the interface block 210 to join as a member of service user, the server management block 221 may provide a function of registering (storing) the member information in the member DB 233 within the database module 230. The member information of a member of service user may be, for example name, e-mail address, phone number, etc., and the tendency information may be, for example gender, age, hobby, region, interests, occupational cluster, etc.

In addition, all of members joining as a member of service user are given a game ability. In this regard, the server management block 221 may assign a middle class of game ability with a member who joins first as a member of service user. For example, assuming that a game ability is preset from the level 1 to the level 10, the first joining member of service user may be assigned with a middle level of game ability, i.e., level 5.

Here, the game ability to be assigned with each member of service user may be adjusted (i.e., up or down of game ability) depending on a game history record of each member of service user to be stored accumulatively with playing an advertisement games, i.e., depending on a success rate of game and average time required for a success game.

Next, when receiving an advertisement to be provided by an advertiser client registered as a member of advertiser via the interface block 210, the game generation block 222 may provide a function of editing the received advertisement to generate a plurality of advertisement games having different game levels each other (difficulty level of game), classifying the plurality of the generated advertisement games into one advertisement group, and assigning a group level before storing it in the advertisement group DB 235. For example, the advertisement may be generated to ten advertisement games having game levels in a range from the level 1 (difficulty level 1 of game) to the level 10 (difficulty level 10 of game). The higher number of the level may be classified into a more difficult game.

In this regard, the reason why a group level is assigned to one advertisement group given for one advertisement is to make a numeral as a parameter, in consideration that a complexity of advertisement content is different each other in each advertisement. For example, in case where the group level is 9 under the assumption that other conditions are same, an easier advertisement game having about the game level (difficulty level of game) 2 may be provided to a game participant. On the contrary, in case where the group level is a lower level, i.e., about the level 3, relatively more difficult game having the game level 8 may be provided to a game participant. By doing this, times for users to stay in each advertisement (advertisement game) may be adjusted similarly.

Further, a group level being assigned to each advertisement group generated by a plurality of advertisement games after editing each advertisement provided by an advertiser client may be adjusted (up or down of group level) on the basis of game history record of each game participant client for a relevant advertisement group per a certain preset period (e.g., 6 hours period, 12 hours period, 18 hours period, 24 hours period, 48 hours period, a week, etc.), for example on the basis of success rate of game for a relevant advertisement group and an average time required for a success of game. In other words, a group level may be adjusted in an inverse proportion to rates of success of the game participant clients for the relevant advertisement and in proportion to an average time required for a success of game. For example, assuming that the group level is preset with ten steps ranging from the level 1 to the level 10, the group level of the advertisement group being registered first may be assigned with a middle level, i.e., level 5.

In addition, when receiving a request of game from a specific client (wired or wireless game participant client), the advertisement group determination block 223 may provide a function of extracting advertisement groups to be exposed on the basis of information related to an advertisement target specified by an advertiser client and personal information of a game participant client, and determining any one of the extracted advertisement groups to be exposed as a targeted advertisement group to be serviced.

Here, the information related to an advertisement target may include, for example at least any one of gender, age, hobby, region, interests, occupational cluster, etc. of a member of service user. The information related to an advertisement target may be personal information corresponding to a member of service user.

More specifically, the advertisement group determination block 223 may determine randomly any one of advertisement groups to be exposed extracted on the basis of information related to an advertisement target specified by an advertiser client and personal information of a game participant client as a target advertisement group to be serviced, or may determine a target advertisement group in a way of generating an advertising list (or advertisement group list) including a plurality of advertisements, and transiting the advertising list to a relevant game participant client, such that the relevant game participant client selects the target advertisement group to be serviced.

Next, the combination block 224 may provide a function of combining at least one of a game mileage for the determined target advertisement group determined by the advertisement group determination block 223, a group level of the determined target advertisement group, times of game experience of a game participant client for the determined target advertisement group, and time elapsed since a game participant client has played the last game in the determined target advertisement group with a game ability of a game participant client, and selecting an advertisement game with a level corresponding to the result value from the combination of the determined target advertisement group. In this regard, a game ability of the relevant game participant client may be adjusted (up or down of game ability) depending on a game history record being stored accumulatively with playing advertisement games, that is, depending on a success rate of game and an average time required for playing the success game.

Further, a game level corresponding to the result value of the combination is proportional to each of a game mileage for the determined target advertisement group, times of game experience of a game participant client for the determined target advertisement group and a game ability of the game participant client, and is inversely proportional to each of a group level and an elapsed time between an initiating time of the selected advertisement game and time for the last game of the games that belongs to the determined target advertisement group.

In addition, when an advertisement game is determined to provide a service from the determined target advertisement group to a game participant client, the reason why a game mileage is used as an independent parameter is to make for a relevant game participant client to stay more in the advertisement game, i.e., for the advertisement to be exposed for a longer time, for example by setting an advertisement game assigned with a relatively more mileage with a relatively higher game level (difficulty level of game).

To this end, the advertisement group DB 235 serves to store therein an advertisement group of each advertisement registered by each advertiser client, a game mileage assigned to each relevant advertisement group and a group level of each advertisement group, information related to an advertisement target, etc., and the game history record DB 237 serves to store therein information such as a game history record of each member of service users, for example, times of game experience, a success rate of game, an average time required for a success game, terminated date and time of the last game, etc. for each advertisement group.

Next, the game play block 225 may has a function of drawing an advertisement game selected through the combination block 224 from the determined target advertisement group within the advertisement group DB 245 so as to provide the selected advertisement game to a game participant client, and playing the advertisement game according to an user's interface from a relevant game participant client. In this regard, the advertisement game to be provided to a game participant client may be a puzzle game wherein an advertisement itself is a game screen such as hidden object game, wrong picture game, a flaw in the crystal game, etc.

Further, when an advertisement game provided to a relevant game participant client is terminated in playing, the game history record management block 226 may provide a function of storing accumulatively information of game (e.g., times of game experience, success or failure of a game, time required for a success game, terminated date and time of a game, etc.) to be generated as a result of playing games for a relevant advertisement game in the game history record DB 237 as a game history record of a relevant game participant client, and providing a game mileage (e.g., cash or point mileage) with playing a game to a relevant game participant client. In this connection, a game mileage of each game participant client acquired through playing a game may be stored in the member DB 233 or in the game history record DB 237.

In addition, a discount rate of game mileage to be provided to a game participant client with playing an advertisement game may be adjusted (or determined) on the basis of times of game experience stored accumulatively according to a game history record of a relevant game participant client, and an elapsed time between an initiating time for a relevant advertisement game and a terminated time for the advertisement game previously played. That is, the discount rate of mileage may be determined in a way of being proportional to times of game experience and being inversely proportional to the elapsed time.

For example, a discount rate of mileage may be determined in a way that if the elapsed time between the time of terminating a current game and the terminated time of the former game is one day, the discount rate will be 50%, and if the elapsed time is 2 days, the discount rate will be 40%, and if the elapsed time is 3 days, the discount rate will be 30%, and if the elapsed time is 4 days, the discount rate will be 20%, and if the elapsed time is 5 days, the discount rate will be 10%, and if the elapsed time is 6 days or more, a normal mileage will be provided. If a game participant client will play advertisement games too often to acquire a game mileage, an actual effectiveness of advertisement may fall, and on the other hand, if a game participant will play advertisement games within a proper time of elapse, an actual effectiveness of advertisement may be achieved. This is a reason to consider such discount rates. Therefore, the embodiment of the present invention can improve an actual effectiveness of advertisement through such discount rates application technique.

Further, when an advertisement game is terminated, and information of result after playing the game is stored in the game history record DB 237 as a game history record, the game ability re-evaluation block 227 may provide a function of re-evaluating a game ability of a relevant game participant client on the basis of an accumulatively stored game history record (e.g., success rate of game, average time required for success game, etc.), and reflecting the result of the re-evaluation on adjusting a level of game ability of a relevant game participant client in order for the game level to leave as it is, or for the game level to go up or down.

Finally, when the current time will be the preset time through checking the current time with a regular interval, the group re-evaluation block 228 may provide a function of re-evaluating a group level for each advertisement group on the basis of game history records (e.g., success rate of game of each game participant client for each advertisement game, average time required for success game) of game participant clients for each advertisement game within each advertisement group, and reflecting the result of the re-evaluation on adjusting a level of each advertisement group in order for the group level of the relevant advertisement group to leave as it is, or in order for the group level to go up or down. In this regard, the group level may be determined in a way of being inversely proportional to the success rate of game and being proportional to the average time required for the success game.

Further, a regular interval for re-evaluating a group level may be set by a server administrator or may be set flexibly depending on the situation of service use for a relevant advertisement group (e.g., an automatic setting in a way of the more service use the shorter regular interval at a certain time, and less service use longer regular interval at a certain time).

Hereinafter, a method for providing an advertisement service using a game to clients (game participant clients) registered as a member of service user through an advertisement service system as set forth above will be described.

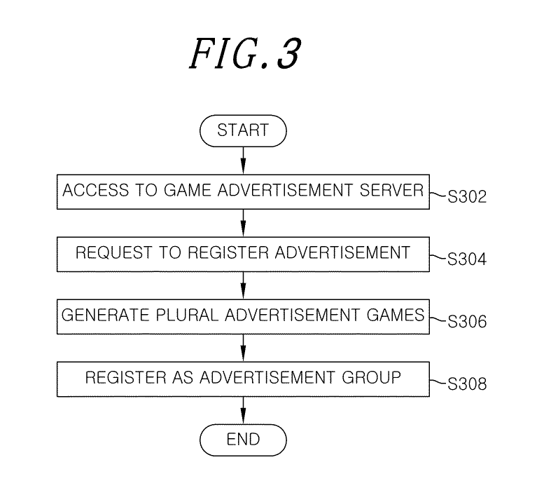

FIG. 3 is a flow chart illustrating a main process for registering an advertisement service for clients, in accordance with the present invention.

For a convenient explanation and an enhanced understanding, first of all, it is assumed that a plurality of members of advertisers have been registered (or signed up) in the game advertisement server.

Referring to FIG. 3, when a specific advertiser client accesses the game advertisement server 112 by log-in while the game advertisement server 112 is in standby mode or execution mode (block S302), the game advertisement server 112 draws a main screen including items of advertisement registration to provide a relevant advertiser client.

Thus, a user of advertiser client may request an advertisement registration in a way of selecting (or inputting) an advertisement to be exposed and an advertising expense of a relevant advertisement through the selection of items of advertisement registration, and transmitting such information to the game advertisement server 112 via the wired communication network 104 (block S304). In this case, the advertisement client may select information related to an advertisement target (e.g., personal information of user, i.e., gender, age, hobby, region, interests, occupational cluster, etc.) for targeting the advertisement and transmit together to the game advertisement server 112.

When at block S304, a registration of advertisement is requested, the game generation block 222 within the advertisement game service module 220 may edit the advertisement received via the interface block 210 to generate a plurality of preset advertisement games having different game levels (difficulty level of game) each other (block S306), and may classify the generated plurality of advertisement games into one advertisement group and store (register) in the advertisement group DB 235 (block S308). For example, an advertisement may be generated to ten advertisement games having ten levels, for example in a range from the level 1 to the level 10. A game with higher number of level may be classified into a more difficult game.

In addition, one advertisement group having a plurality of advertisement games with different game levels each other generated from one advertisement may be assigned with a group level. In this regard, the advertisement to be registered first may be assigned with a middle group level by the game generation block 222.

Therefore, each of advertisers may, at any time, be able to register (registration of an advertisement group having a plurality of advertisement games) desired advertisements into the game advertisement server 112 through a series of process as described above.

Next, a series of process will be described to provide each user of service (game participant client) with an advertisement game service by utilizing the advertisement group having a plurality of advertisement games with different game levels each other generated from one advertisement and registered into the game advertisement server 112 through the process as set forth above.

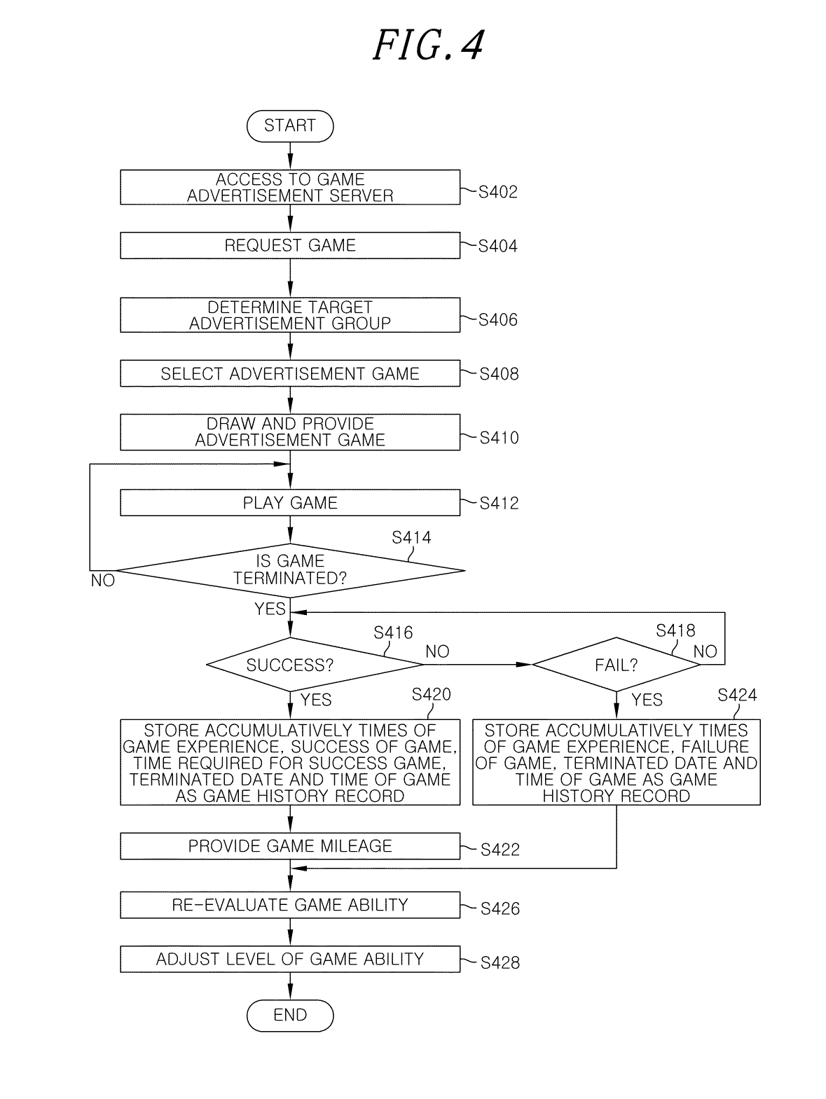

FIG. 4 is a flow chart illustrating a main process for providing clients with an advertisement service using a game, in accordance with an embodiment of the present invention.

For a convenient explanation and an enhanced understanding, first of all, it is assumed that a plurality of members of service users have been registered (or signed up).

Referring to FIG. 4, when any game participant client (wired or wireless game participant client) accesses to the game advertisement server 112 by log-in while the game advertisement server 112 is in standby mode or execution mode (block S402), the game advertisement server 112 draws a main screen including items of game request to provide a relevant game participant client.

Next, when a game participant client requests a game in a manner of selecting (e.g., click, etc.) an item of game request (block S404), the advertisement group determination block 223 within the game advertisement server may extract advertisement groups to be exposed on the basis of information related to an advertisement target specified by each advertiser client and personal information of a game participant client, and may determine any one of the extracted advertisement groups to be exposed as a target advertisement group to be serviced (block S406). In this regard, information related to an advertisement target may include, for example at least any one of gender, age, hobby, region, interests, occupational cluster of a member of service user, and the information related to an advertisement target may correspond to the personal information corresponding to the member of service user.

In this case, a target advertisement group to be serviced that is determined among the extracted advertisement groups to be exposed may be, for example determined randomly by the advertisement group determination block 223, or the advertisement group determination block 223 may be processed in a manner that a relevant game participant client selects a desired advertisement group, after generating a list of advertisement (or a list of advertisement group) including a plurality of advertisements to transmit to a relevant game participant client.

Subsequently, the combination block 224 combines at least any one of a game mileage for the determined target advertisement group determined by the advertisement group determination block 223, times of game experience of a game participant client for the determined target advertisement group and time elapsed since a game participant client has played the last game in the determined target advertisement group with a game ability of a game participant client and selects an advertisement game with a level corresponding to the result value of the combination from the determined target advertisement group (block S408). Here, the game ability of a relevant game participant client may be adjusted (up or down of game ability) by a game history record (success rate of game and average time required for success game) being stored accumulatively with playing advertisement games. In this regard, a level of game corresponding to the result value of the combination may be determined in a way of being proportional to a mileage for a relevant advertisement group, times of game experience of a game participant client for the determined target advertisement group and a game ability of a game participant client, and being inversely proportional to a group level and an elapsed time between an initiating time of a selected advertisement game and a terminated time of the last game belonged to the determined target advertisement group.

In response to this, the game play block 225 draws an advertisement game with a level (game level) selected by the combination block 224 from the determined target advertisement group to provide to the relevant game participant client (block S410). As a result, an advertisement game is played according to the user's interface of the relevant game participant client (block S412). For example, the advertisement game may be any one of a puzzle game wherein an advertisement itself is composed of a game screen, hidden object game, wrong picture game, a flaw in the crystal game, etc.

Next, at block S414, it is checked whether an advertisement game playing by the relevant game participant client is terminated or not. If the game is determined to be terminated from the check result, the game history record management block 226 checks whether the relevant advertisement game has been succeeded or failed (blocks S416 and S418). Here, the termination of the advertisement game may be any one of a termination by a success of game, a termination by limited time out (failure of game) and a forced termination by the user's choice during the game.

As a check result at block S416, if the advertisement game is determined to be succeeded, the game history record management block 226 stores accumulatively information about the game play result including times of game experience, a success of game, time required for a success game, terminated date and time of a game, etc. in the game history record DB 237 as a game history record for a relevant game participant client (block S420).

Thereafter, the game history record management block 226 provides a game mileage (e.g., cash, point mileage, etc.) with playing games to a relevant game participant client (block S422). The acquired game mileage of a relevant game participant client may be stored in the member DB 233 or in the game history record DB 237. In the game history record management block 226, a discount rate of game mileage may be adjusted on the basis of times of game experience of the determined target advertisement group being stored accumulatively with a game history record of the relevant game participant client and an elapsed time between an initiating time of the relevant advertisement game and a terminated time of the previously played advertisement game. That is, a discount rate of mileage may be determined in a way of being proportional to times of game experience, and being inversely proportional to an elapsed time.

For example, a discount rate of mileage may be determined in a way that if the elapsed time between the time of terminating a current game and the terminated time of the former game is one day, the discount rate will be 50%, and if the elapsed time is 2 days, the discount rate will be 40%, and if the elapsed time is 3 days, the discount rate will be 30%, and if the elapsed time is 4 days, the discount rate will be 20%, and if the elapsed time is 5 days, the discount rate will be 10%, and if the elapsed time is 6 days or more, a normal mileage will be provided.

As a check result at block S418, if the advertisement game is determined to be failed, the game history record management block 226 stores accumulatively information of game play result including times of game experience, a failure of game, terminated date and time of a game, etc. in the game history record DB 237 as a game history record for a relevant game participant client (block S424). The process then advances to block S426.

Next, the game ability re-evaluation block 227 re-evaluates a game ability of the relevant game participant client on the basis of a game history record (e.g., success rate of game and average time required for success game) stored accumulatively in the game history record DB 237 (block S426) and reflects the result of re-evaluation on adjusting a level of game ability of a game participant client (block S428). In other words, on the basis of the result of re-evaluation, a game ability of a relevant game participant client may leave without a change, or may up or down. The game ability of a relevant game participant client reflected by the result of the re-evaluation may be stored in the member DB 233.

Thus, each client (wired or wireless client) registered in the game advertisement server as a member of service user can achieve a game mileage being paid for the exposure to the advertisement while enjoying a game through an advertisement game service provided by the game advertisement server, as described above.

Next, a series of process of adjusting a group level assigned to each advertisement group of each advertisement registered in the game advertisement server on the basis of game history records of each of service users will be described.

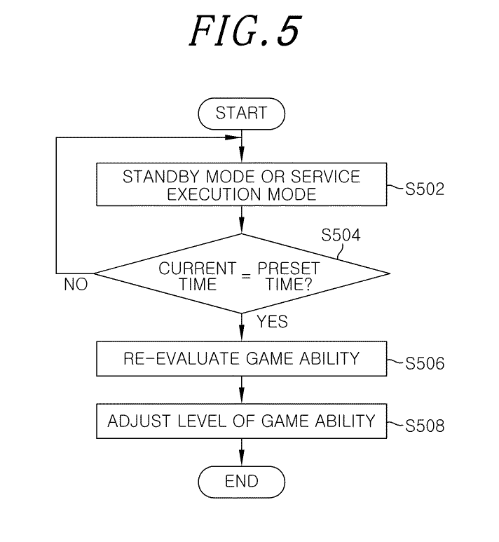

FIG. 5 is flow chart illustrating a main process including re-evaluating the group level of each advertisement group and reflecting on the adjustment of the group level, in accordance with the present invention.

Referring FIG. 5, while the game advertisement server is in standby mode or in service execution mode (block S502), the group level re-evaluation block 228 checks a current time with a regular interval to check whether a current time has been reached to a preset time (block S504).

Here, the regular interval for a group level re-evaluation may be set by a server administrator or may be set flexibly (i.e., more service use shorter regular interval relatively, and less service use longer regular interval relatively).

As a check result at block S504, in case where the current time is determined to be reached to the preset time, the group level re-evaluation block 228 re-evaluates a group level for each advertisement group on the basis of game history records (e.g., a success rate of game and time required for success game, etc. for each advertisement group of each game participant client) of a plurality of game participant clients (service users) for each advertisement game within each advertisement group stored in the game history record DB 237.

After that, the group level re-evaluation 228 reflects each re-evaluation result on adjusting a group level for each advertisement group, that is, executes a group level adjustment in a manner of leaving a group level as it is or going up or down on the basis of the re-evaluation result. Here, the group level of each advertisement group may be adjusted in a way of being inversely proportional to success rates of games of a plurality of game participant clients, and being proportional to average times required for success games.

In accordance with the present invention, therefore, a group level of each advertisement group is adjusted in consideration of current using status, etc. of service users (game participant clients) for each advertisement group. Here, the meaning of higher group level is that it may take longer time for game participant clients to play an advertisement game belonged to a relevant advertisement group, or that a success rate of game may be low. In general, if the original advertisement (image of advertisement or video of advertisement) received from the advertiser is complex or difficult, the group level of the advertisement group having advertisement games generated from such a complex and difficult advertisement comes to be high. On the other hand, time to complete an advertisement game belonged to a low group level of advertisement group may be relatively shorter. Because of this, for the execution of a game belonged to high group level of advertisement group, an advertisement game having more or less low game level (difficulty level of game) is provided to an user of game, and on the other hand, for the execution of an advertisement game belonged to a low group level of advertisement group, a little bit difficult game is provided to an user of game. By doing this, it may be kept constantly for users to stay in each advertisement (advertisement game).

The explanation as set forth above is merely described a technical idea of the exemplary embodiments of the present invention, and it will be understood by those skilled in the art to which this invention belongs that various changes and modifications may be made without departing from the scope of the essential characteristics of the embodiments of the present invention.

1. A method for providing an advertisement service using a game, the method comprising:
when receiving a request for the game from a game participant client, extracting advertisement groups to be exposed on the basis of information related to an advertisement target specified by an advertiser client and personal information of the game participant client and determining any one of the extracted advertisement groups to be exposed as a target advertisement group to be serviced;
combining a game ability of the game participant client with at least any one of a game mileage of the determined target advertisement group, group level of the determined target advertisement group, times of game experience of the game participant client in the determined target advertisement group, and time elapsed since the game participant client has played the last game in the determined target advertisement group;
selecting an advertisement game having a game level corresponding to the result value of the combination from the determined target advertisement group, wherein the determined target advertisement group includes a plurality of advertisement games, the advertisement games having different game levels each other and being generated from the same advertisement;
providing the selected advertisement game to the game participant client so as for the game participant client to play the selected advertisement game; and
when the selected advertisement game is terminated, storing accumulatively information related to the game play result derived from playing the selected advertisement game in a database as a personal history record of the game participant client.

2. (canceled)

3. The method of claim 1, further comprising:
after said storing accumulatively information related to the game play result,
determining another of the advertisement groups to be exposed as a target advertisement group to be serviced; and
executing repeatedly operations from said combining a game ability of the game participant client to said storing accumulatively information with respect to the determined another target advertisement group.

4. The method of claim 1, further comprising:
after said storing accumulatively information related to the game play result,
re-evaluating the game ability of the game participant client on the basis of the game history record stored accumulatively; and
reflecting the result of the re-evaluation for the game ability on the adjustment of the game ability of the game participant client,
wherein the game history record used for re-evaluating the game ability comprises a success rate of game and an average time requested for a success game of the game participant client.

5. (canceled)

6. The method of claim 1, further comprising:
when the selected advertisement game is terminated,
providing a game mileage obtained by playing a game to the game participant client.

7. The method of claim 1, further comprising:
when a preset regular time comes,
re-evaluating a group level for the determined target advertisement group on the basis of the game history records of a plurality of game participant clients for each advertisement game within the determined target advertisement group; and
reflecting the re-evaluation result of the group level to the adjustment of a group level of the determined target advertisement group,
wherein the game history record used for re-evaluating the group level comprises success rates of game and average times required for success games of a plurality of game participant clients.

8. (canceled)

9. A method for providing an advertisement service using a game, the method comprising:
when an advertisement to be serviced is received from each advertiser client, editing the received advertisement to generate a plurality of advertisement games having different game levels each other;
registering the plurality of advertisement games, which have different game levels each other and are generated from the same advertisement, as one advertisement group;
when receiving a request for a game from a game participant client, extracting advertisement groups to be exposed on the basis of information related to an advertisement target specified by an advertiser client and personal information of the game participant client and determining any one of the extracted advertisement groups as a target advertisement group to be serviced;
combining at least any one of a game mileage of the determined target advertisement group, group level of the determined target advertisement group, times of game experience of the game participant client in the determined target advertisement group, and time elapsed since the game participant client has played the last game in the determined target advertisement group, with a game ability of the game participant client;
selecting an advertisement game having a game level corresponding to the result value of the combination from the determined target advertisement group;
providing the selected advertisement game to the game participant client so as for the game participant client to play the selected advertisement game; and
when the selected advertisement game is terminated, storing accumulatively information related to the game play result derived from playing the selected advertisement game in a database as a personal history record of the game participant client.

10. (canceled)

11. The method of claim 9, further comprising:
after said storing accumulatively information related to the game play result,
determining another of advertisement groups to be exposed as a target advertisement group to be serviced; and
executing repeatedly from said combining to said storing accumulatively with respect to the determined another target advertisement group.

12. The method of claim 9, wherein the game ability is determined on the basis of a success rate of game and an average time required for a success game of the game participant client.

13. The method of claim 9, wherein the game level corresponding to the result value of the combination is determined in a way of being proportional to times of game experience of the game participant client for the determined target advertisement group and a game ability of the game participant client, and being inversely proportional to the group level and an elapsed time between an initiating time of the selected advertisement game and a last game time for the advertisement game belonged to the advertisement groups.

14. (canceled)

15. The method of claim 9, further comprising:
after storing accumulatively information related to the game play result in the database,
re-evaluating a game ability of the game participant client on the basis of a game history record stored accumulatively;
reflecting the result of the re-evaluation for the game ability on the adjustment of a game ability of the game participant client; and
when the selected advertisement game is terminated, providing a game mileage obtained by playing a game to the game participant client,
wherein the game history record using for re-evaluating the game ability comprises a success rate of game and an average time requested for a success game of the game participant client.

16. (canceled)

17. (canceled)

18. The method of claim 15, wherein a discount rate of the game mileage is adjusted on the basis of times of game experience of the game participant client for the determined target advertisement group stored accumulatively with the game history record of the game participant client and an elapsed time between an initiating time of the selected advertisement game and a terminated time of the advertisement game within the determined target advertisement group.

19. The method of claim 18, wherein the discount rate of the game mileage is determined in a way of being proportional to the times of game experience and being inversely proportional to the elapsed time.

20. The method of claim 9, further comprising:
when a preset time comes, re-evaluating a group level for the determined target advertisement group on the basis of game history records of a plurality of game participant clients for each advertisement game within the determined target advertisement group; and
reflecting the result of the re-evaluation for the group level on the adjustment of a group level of the determined target advertisement group,
wherein the game history record used for the re-evaluation for the group level comprises success rates of game and average times requested for success games of the plurality of game participant clients.

21. (canceled)

22. The method of claim 20, wherein the group level is adjusted in a way of being inversely proportional to the success rate of a game and being proportional to the average time required for the success game.

23. (canceled)

24. A system for providing an advertisement service using a game, the system comprising:
a game generation block configured to generate a plurality of advertisement games having different game levels each other through editing an advertisement provided by each advertiser client and register the plurality of advertisement games, which have different game levels each other and are generated from the same advertisement received, in the database as an advertisement group, wherein the plurality of advertisement games;
an advertisement group determination block, upon receiving a request for a game from a game participant client, configured to extract advertisement groups to be exposed on the basis of information related to an advertisement target specified by an advertiser client and personal information of the game participant client and determines any one of the extracted advertisement groups to be exposed as a target advertisement group to be serviced;
a combination block configured to combine at least any one of a game mileage of the determined target advertisement group, group level of the determined target advertisement group, times of game experience of the game participant client in the determined target advertisement group, and time elapsed since the game participant client has played the last game in the determined target advertisement group, with a game ability of the game participant client;
a game play block configured to select an advertisement game having a game level corresponding to the result value of the combination from the determined target advertisement group and provide the selected advertisement game to the game participant client so as for the game participant client to play the advertisement game;
a game history record management block, when the selected advertisement game is terminated, configured to store accumulatively information related to the game play result derived from playing the selected advertisement game in a database as a personal history record of the game participant client; and
a game ability re-evaluation block, when the information of game on the play result is stored accumulatively as a game history record, configured to re-evaluate a game ability of the game participant client on the basis of the game history record stored accumulatively and reflect the result of the re-evaluation on adjusting a game ability of the game participant client.

25. (canceled)

26. The system of claim 24, wherein the game ability re-evaluation block re-evaluates the game ability on the basis of a success rate of game and an average time required for a success game of the game participant client.

27. The system of claim 24, further comprising:
a group re-evaluation block, when a preset time comes, configured to re-evaluate a group level of the determined target advertisement group on the basis of game history records of the plurality of game participant clients for each advertisement game within the determined target advertisement group and reflect the result of the re-evaluation on adjusting a group level of the determined target advertisement group.

28. The system of claim 27, wherein the group level re-evaluation block re-evaluates the group level on the basis of success rates of game and average times required for success games of the plurality of game participant clients.

29. (canceled)

30. The system of claim 24, wherein when the selected advertisement game is terminated, the game history record management block provides a game mileage with playing a game to the game participant client.

31. The system of claim 30, wherein the game history record management block adjusts a discount rate of game mileage on the basis of times of game experience of the game participant client for the determined target advertisement group stored accumulatively with the game history record of the game participant client and an elapsed time between an initiating time of the selected advertisement game and a terminated time of the advertisement game within the determined target advertisement group.

32. (canceled)
